(19) United States
(12) Patent Application Publication
(10) Pub. No.: US 2018/0313312 A1
(43) Pub. Date: Nov. 1, 2018

(54) HIGH-PRESSURE FUEL PUMP FOR A FUEL INJECTIN SYSTEM

(71) Applicant: CONTINENTAL AUTOMOTIVE GMBH, Hannover (DE)

(72) Inventors: Bernd Wöllisch, Chamerau (DE); Lars Köhler, Chamerau (DE); Michael Mauer, Regensburg (DE); Stefan Dierks, Wörth (DE)

(73) Assignee: CONTINENTAL AUTOMOTIVE GMBH, Hannover (DE)

(21) Appl. No.: 15/964,394

(22) Filed: Apr. 27, 2018

(30) Foreign Application Priority Data
Apr. 26, 2017 (DE) 10 2017 207 044.7

(51) Int. Cl. F02M 59/02; F02M 55/00

(52) U.S. Cl. CPC F02M 59/025; F02M 59/44; F02M 55/002

(57) ABSTRACT

The invention relates to a high-pressure fuel pump having a pump piston and having a piston rotation inducing device which induces a rotation of the pump piston about a movement axis, along which the pump piston moves in translational fashion, during the operation of the pump piston

### CROSS-REFERENCE TO RELATED APPLICATION

This application claims priority to German application No. 10 2017 207 044.7, filed on Apr. 26, 2017, each of which is hereby incorporated by reference herein in its entirety.

### TECHNICAL FIELD

The invention relates to a high-pressure fuel pump for applying high pressure to a fuel in a fuel injection system.

### BACKGROUND

High-pressure fuel pumps in fuel injection systems are used to apply a high pressure to a fuel, wherein the pressure lies for example in a range from 150 bar to 400 bar in gasoline internal combustion engines and in a range from 1500 bar to 3000 bar in diesel internal combustion engines. The greater the pressure which can be generated in the particular fuel, the lower the emissions which arise during the combustion in a combustion chamber.

Such high-pressure fuel pumps are commonly designed as piston pumps, in which a pump piston moves in translational fashion along a movement axis in a housing bore which forms a pressure chamber, and said pump piston, by means of said movement, compresses and thus applies a high pressure to a fuel arranged in the pressure chamber.

For example, the pump piston is guided in a guide bore in a housing, wherein it is known, for example from the field of high-pressure gasoline pumps, for the pump piston to be guided in a type of sleeve as tribological partner, in which said pump piston performs a high-frequency movement in an axial direction. The pump piston exhibits a high hardness, good surface area values, and also a coating for wear prevention. Owing to the high-frequency movement in an axial direction, combined with lateral forces that arise during operation, the pump piston however commonly wears at a particular location, to the point of piston seizure. This is because an abutment of the pump piston against its tribological partner, the sleeve, is generated at the same location of the pump piston owing to lever ratios, lateral forces etc. increased friction thus arises at this location in the sleeve and also on the pump piston, which leads to increased wear for example on the coating and on the pump piston itself and can lead to piston seizure.

The background description provided herein is for the purpose of generally presenting the context of the disclosure. Work of the presently named, inventors, to the extent it is described in this background section, as well as aspects of the description that may not otherwise qualify as prior art at the time of filing, are neither expressly nor impliedly admitted as prior art against the present disclosure.

### SUMMARY

A high-pressure fuel pump for applying high pressure to a fuel in a fuel injection system has a housing having a housing bore, which housing bore forms, at one end region, a pressure chamber in which high pressure is applied to the fuel, and which housing bore forms a guide bore which adjoins the end region and which serves for guiding a pump piston.

The high-pressure fuel pump further comprises a pump piston which is guided in the guide bore and which moves in translational fashion in the guide bore along a movement axis during the operation of the high-pressure fuel pump. A piston rotation inducing device is provided in the high-pressure fuel pump, which piston rotation inducing device induces a rotation of the pump piston about the movement axis during the operation of the pump piston.

Accordingly, a high-pressure fuel pump is disclosed in which the normally purely axial high-frequency upward and downward movement of the pump piston along the movement axis is combined with a targeted rotation of the pump piston. In this way, the increased wear on the pump piston and guide bore, which is provided for example by a sleeve, at only one particular location is eliminated or at least reduced. The relatively lower wear on the components involved gives rise to an increased service life in relation to known high-pressure fuel pumps. Additionally, the optimization of the internal friction of the high-pressure fuel pump gives rise to a lower drive torque and thus lower CO₂ consumption.

The guide bore may be provided for example by a housing wall itself, though it is also possible for an additional sleeve to be inserted into the housing bore of the housing, in order to thereby form the guide bore within the housing bore by means of an external element.

There may be, between a guide wall of the guide bore and a piston shell surface of the pump piston, there is provided a defined piston clearance through which leakage fuel flows out of the pressure chamber parallel to the movement axis during the operation of the pump piston, wherein the piston shell surface has a surface structure which interacts with the flowing leakage fuel such that the pump piston rotates about the movement axis.

Accordingly, the piston rotation inducing device is formed by the special surface structure on the piston shell surface, which can effect the rotation of the pump piston even when the leakage fuel flows from the pressure chamber along the piston shell surface in the piston clearance between guide wall and piston shell surface. The application of the special surface structure to the piston shell surface therefore effects a targeted rotational movement during the operation of the pump piston, whereby the wear at one location can be considerably reduced or even prevented. By means of this special surface structure, a targeted flow of the leakage fuel as surrounding medium is realized, which imparts a rotational movement component to the movable pump piston in addition to its purely axial movement along the movement axis.

In one embodiment, the surface structure extends over the piston shell surface parallel to the movement axis of the pump piston, wherein the surface structure extends in particular may be over a full length of the piston shell surface parallel to the movement axis.

In this way, the leakage fuel flowing over the piston shell surface may interact with the surface structure, and the rotational movement of the pump piston may be induced over the entire length of the pump piston.

The surface structure may be arranged in helical fashion on the piston shell surface. A helix winds in spiral form around the piston shell surface and can thus contribute to a relatively high degree of symmetry of the surface structure on the piston shell surface in relation to the movement axis.

A helix gradient of the surface structure may be of such a magnitude that said structure winds at most once around a circumference of the pump piston.

Multiple helical surface structures may be arranged parallel, for example at least four, may he arranged on the piston shell surface.

The greater the number of parallel surface structures which are provided, the greater are the degree of symmetry and thus the uniformity of the rotational movement which is induced. Wear of the pump piston and guide bore is thereby counteracted.

In one exemplary embodiment, the helical surface structure is formed by a continuous helix. It is however alternatively also possible for the helical surface structure to be formed by a discontinuous helix. If multiple helices are arranged on the piston shell surface, it is possible for one part thereof to be formed by continuous helices and for another part to be formed by discontinuous helices.

By means of the number and design of the surface structure, the flow speed of the leakage fuel and also the flow direction of the leakage fuel surrounding the pump piston may be influenced, which influences the rotational movement of the pump piston. It is therefore possible for the number of surface structures, the shape and the design to be varied in a manner dependent on the desired rotational movement component.

The surface structure may be formed as a relief which is recessed into the piston shell surface and which is formed into the piston shell surface in particular by laser removal. The surface structure thus forms ducts along the movement axis, in which ducts the leakage fuel can flow.

A depth of the recessed relief may lie in a range between 2 μm and 5 μm. This depth is sufficient to conduct enough leakage fuel into the recessed relief that a rotational movement can be induced in the pump piston by the movement force exerted by the leakage fuel.

In an embodiment, the guide bore may be formed as an optimum cylinder with a cylindrical shape deviation and/or a surface roughness of the guide wall of the guide bore at most in the μm range. As a result of the guide bore being formed as an optimum cylinder, in conjunction with the surface structure on the pump piston, it is possible for the rotational movement of the pump piston to be set in targeted fashion merely through variation of the surface structure on the piston shell surface, because a guide wall of the guide bore has only little influence on the movement direction of the leakage fuel.

A piston clearance between a guide wall of the guide bore and a piston shell surface of the pump piston may lie in a range below 4 μm, may be below 3.5 μm, and may be between 2 μm and 3 μm. The piston clearance may be therefore reduced by approximately 30% in relation to known applications, which has the effect that the flow speed and also the direction of the leakage fuel surrounding the pump piston can be influenced, which imparts a greater rotational movement component to the pump piston.

The elements that have an influence on the rotation of the pump piston are accordingly, but not limited to the shape of the guide bore, the shape of the surface structure, the depth of the surface structure, and the piston clearance.

Accordingly, if a greater degree of wear is expected for example owing to an increased introduction of lateral force, this may be reduced in targeted fashion by means of a reduction of the piston clearance, by means of a specific surface structure on the pump piston, and also the shape of the guide bore a rotation of the pump piston. The location of the wear is in this case not always situated at the same spatial location throughout the service life, as previously, but rather rotates through 360°. In this way, the service life can be considerably lengthened.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein

FIG. 1 shows a schematic sectional illustration of a housing of a high-pressure fuel pump having a pump piston in a first embodiment guided in a guide bore;

FIG. 2 shows a perspective illustration of the pump piston from FIG. 1 in a second embodiment; and

FIG. 3 shows a perspective illustration of the pump piston from FIG. 1 in a third embodiment.

### DETAILED DESCRIPTION

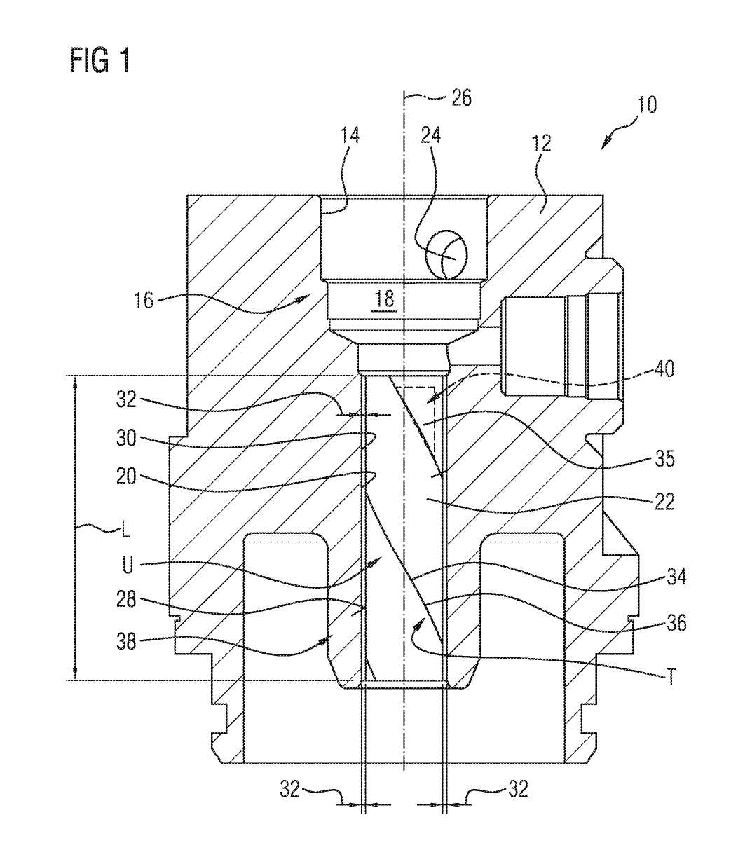

FIG. 1 shows a schematic sectional illustration of a high-pressure fuel pump 10 with which high pressure is applied to a fuel, in particular gasoline. The high-pressure fuel pump 10 has a housing 12 in which there is formed a housing bore 14 which, at one end region 16, forms a pressure chamber 18. Adjoining the end region 16, the housing bore 14 forms a guide bore 20, in which a pump piston 22 is arranged. During operation, fuel is supplied to the pressure chamber 18 via a feed bore 24. The pump piston 22 moves upward and, downward in the guide bore 20 along a movement axis 26 and thereby reduces the volume of the pressure chamber 10. In this way, the fuel situated in the pressure chamber 18 is compressed, and thus has high pressure applied thereto.

In the present embodiment, the guide bore 20 is formed directly in the housing 12. It is however also conceivable for an additional sleeve to be inserted into the housing bore 14, in which sleeve the guide bore 20 for the pump piston 22 is formed.

A piston clearance 32 is prodded between a piston shell surface 28 of the pump piston 22 and a guide wall 30 of the guide bore 20. Owing to the piston clearance 32, the pump piston 22 can easily move upward and downward in translational fashion in the guide bore 20. The piston clearance 32 additionally serves for the lubrication and cooling of the pump piston 22 during operation, wherein leakage fuel can flow out of the pressure chamber 18 along the piston shell surface 28 in the piston clearance 32.

The piston shell surface 28 has a surface structure 34 which, in the embodiment shown in FIG. 1, is formed as a helical surface structure 34—helix 35—in the form of a recessed relief 36.

If the leakage fuel now flows down along the piston shell surface 28 on the pump piston 22 in the piston clearance 32, said leakage fuel also enters the relief 36 and flows along the helix 35 that is formed. Here, the flowing leakage fuel exerts a movement force on the pump piston 22, which has the effect that the pump piston 22 begins to rotate about the movement axis 26. The combination of the surface structure 34 with the flowing leakage fuel from the pressure chamber 18 thus forms a piston rotation inducing device 38.

To effect an expedient rotation of the pump piston 22 about the movement axis 26, a depth T of the relief 36, that is to say of the surface structure 34, lies a range of the magnitude of the piston clearance 32, though may also be greater depending on the usage situation. For example, a piston clearance 32 is reduced by 30% in relation to known high-pressure fuel pumps 10, and lies in a size range below 4 μm, in particular below 3.5 μm, and lies approximately in a range between 2 μm and 3 μm. Correspondingly the depth T of the relief 36 may lie in a size range between 2 μm and 5 μm. The recessed relief 36 may for example be formed into the piston shell surface 28 by laser.

In order that substantially the surface structure 34 effects the rotation of the pump piston 22 about the movement axis 26, guide bore 20 may be formed as an optimum cylinder, that is to say as a cylinder which has only a very slight cylindrical shape deviation and also only a very low surface roughness. Thus, the cylindrical shape deviation and surface roughness of the guide wall 30 may lie at most in the μm range.

To achieve that the rotation of the pump piston 22 about the movement axis 26 is influenced over an entire length L of the piston shell surface 28 parallel to the movement axis 26, the surface structure 34 may extend on the piston shell surface 28 over the full length L parallel to the movement axis 26.

Depending on the rotation of the pump piston 22 about the movement axis 26, different surface structures 34 may be used.

FIG. 1 show, in a first embodiment, the use of a single helix 35 which winds around the entire piston shell surface 28.

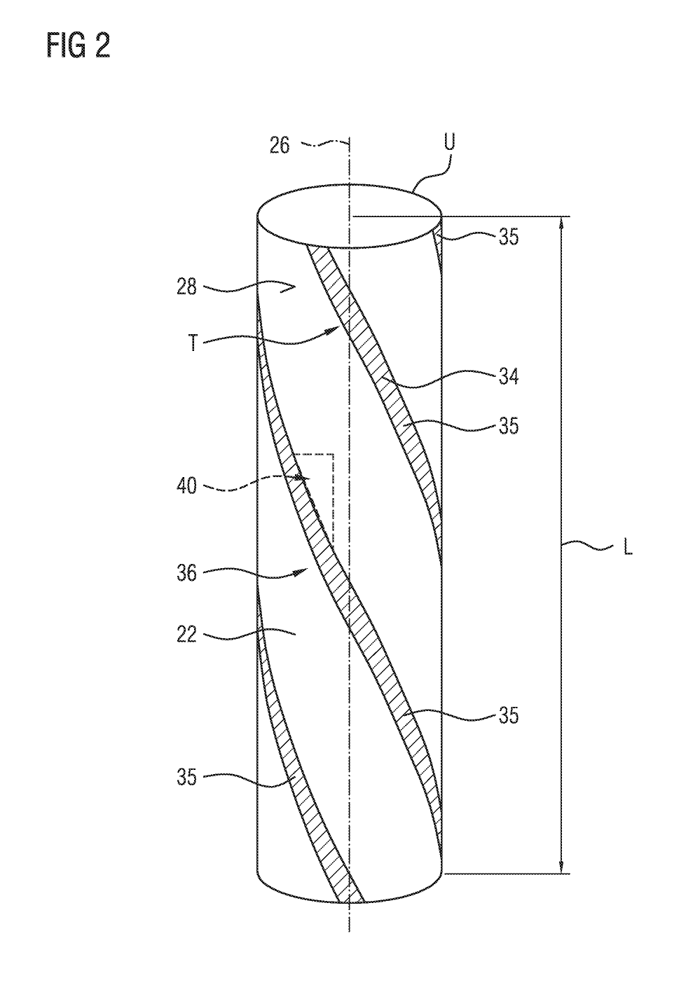

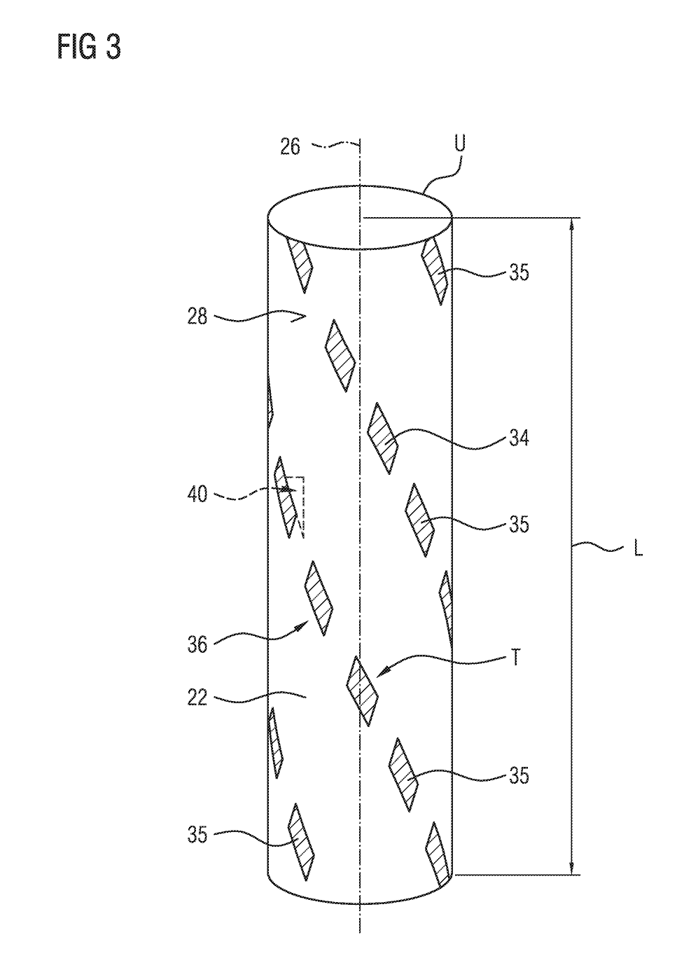

FIG. 2 shows a second embodiment of the pump piston 22, wherein multiple helical surface structures 34 which extend parallel to one another are arranged on the piston shell surface 28. In the present embodiment, four parallel helices 35 are arranged on the piston shell surface 28. A helix gradient 40 of said four helices 35 is in each case of such a magnitude that said helices wind in each case only once around a circumference U of the pump piston 22. In FIG. 2, the helices 35 are formed as continuous helices, that is to say are formed continuously over the full extent. FIG. 3 shows an alternative third embodiment, in which the helices 35 are formed as discontinuous helices 35.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A high-pressure fuel pump for applying high pressure to a fuel in a fuel injection system comprising:
a housing defining a housing bore and a guide bore;
a pressure chamber formed at one end region of the housing bore in which high pressure is applied to the fuel, and wherein the guile bore adjoins the end region;
a pump piston, guided by the guide bore, wherein the pump piston is translatable in the guide bore along a movement axis during the operation of the high-pressure fuel pump; and
a piston rotation inducing device which a rotation of the pump piston about the movement axis during the operation of the pump piston.

2. The high-pressure fuel pump of claim 1, wherein a piston clearance is defined between a guide wall of the guide bore and a piston shell surface of the pump piston, and through which leakage fuel flows out of the pressure chamber parallel to the movement axis during the operation of the pump piston.

3. The high-pressure fuel pump of claim 2, wherein the piston shell surface has a surface structure which interacts with the flowing leakage fuel such that the pump piston rotates about the movement axis

4. The high-pressure fuel pump of claim 3, wherein the surface structure extends over the piston shell surface parallel to the movement axis of the pump piston.

5. The high-pressure fuel pump of claim 4, wherein the surface structure extends over a full length the piston shell surface parallel to the movement axis.

6. The high-pressure fuel pump of claim 3, wherein the surface structure is arranged helically on the piston shell surface.

7. The high-pressure fuel pump of claim 6, wherein a helix gradient of the surface structure is of a magnitude such that said structure winds at most once around a circumference of the pump piston.

8. The high-pressure fuel pump of claim 6, wherein multiple helical surface structures are arranged parallel on the piston shell surface.

9. The high-pressure fuel pump of claim 6, wherein the helical surface structure is formed by one of a continuous helix and a discontinuous helix.

10. The high-pressure fuel pump of claim 3, wherein the surface structure is a relief recessed into the piston shell surface.

11. The high-pressure fuel pump of claim 11, wherein the relief is formed into the piston shell surface by laser removal.

12. The high-pressure fuel pump of claim 10, wherein a depth of the recessed relief lies in a range between 2 μm and 5 μm.

13. The high-pressure fuel pump of claim 2, wherein a piston clearance between a guide wall of the guide bore and a piston shell surface of the pump piston is smaller than 4 μm.

14. The high-pressure fuel pump of claim 13, wherein the piston clearance is smaller than 3.5 μm.

15. The high-pressure fuel pump of claim 13, wherein the piston clearance between lies between 2 μm and 3 μm.

16. The high-pressure fuel pump of claim 1, wherein the guide bore is formed as an optimum cylinder with a cylindrical shape deviation.

17. The high-pressure fuel pump of claim 1, wherein a surface roughness of a guide wall of the guide bore is in the μm range.
